(19) United States
(12) Patent Application Publication
(10) Pub. No.: US 2026/0119609 A1
(43) Pub. Date: Apr. 30, 2026

(54) TRAINING DATA RECOMMENDATION SYSTEM AND TRAINING DATA RECOMMENDATION METHOD

(71) Applicant: Hitachi, Ltd., Tokyo (JP)

(72) Inventors: Takehiro HAGIWARA, Tokyo (JP); Akihiko HYODO, Tokyo (JP); Keiro MURO, Tokyo (JP); Hitoshi ISHIDA, Tokyo (JP); Shintaro SUZUKI, Tokyo (JP); Riku KAWAMURA, Tokyo (JP); Yuichiro AOKI, Tokyo (JP); Tomoki KASAI, Tokyo (JP)

(21) Appl. No.: 19/229,330

(22) Filed: Jun. 5, 2025

(30) Foreign Application Priority Data
Oct. 30, 2024 (JP) 2024-191187

(51) Int. Cl. G06F 18/214; G06Q 30/0202

(52) U.S. Cl. CPC G06F 18/214; G06Q 30/0202

(57) ABSTRACT

A training data recommendation system includes a processor and a memory. The processor performs data collection processing of acquiring training data to be used by an estimation model for training, model accuracy estimation processing of estimating accuracy of an estimation result of the estimation model in a case where the estimation model is trained using the training data, training cost calculation processing of calculating a cost required in the case where the estimation model is trained using the training data, processing of calculating revenue obtained by provision of the estimation result output in the case where the estimation model is trained using the training data, and processing of outputting a training data recommendation result, for which a profit obtained by training of the estimation model is calculated, based on the cost and the revenue.

### CROSS-REFERENCE TO RELATED APPLICATION

The present application claims priority from Japanese application JP2024-191187, filed on Oct. 30, 2024, the content of which is hereby incorporated by reference into this application.

### BACKGROUND OF THE INVENTION

### 1. Field of the Invention

The present invention relates to a system and a method for recommending training data.

### 2. Description of Related Art

In recent years, in order to optimize power usage in a region, a mechanism called demand response (DR) has been used, which promotes suppression of power consumption of a power consumer such as a household or a factory when power demand is tight, and conversely promotes increase of power consumption of the power consumer when power supply is excessive due to power generation of renewable energy or the like.

A method of providing an incentive or the like according to an adjustment amount of the power consumption of the power consumer during a DR execution period has been studied.

In the related art, a technique of predicting a power demand amount in a target region has been known. Further, a technique of estimating which device is operated at which time to generate a power demand for a power demand amount has been known.

Further, there has been known a technique of predicting power supply by renewable energy based on an introduction ratio of renewable energy power generation devices, weather data, arrangement information of buildings, and the like in a target region.

It is considered that a combination of these techniques makes it possible to predict the power demand amount for each device, a power supply amount by renewable energy, and an excess or deficiency of the power demand amount and the power supply amount in the target region.

Accordingly, by predicting the power demand of a device whose operation time zone can be changed and the operation time zone, it is possible to estimate an adjustable amount (coordination potential) of the power consumption of the consumer during the DR execution period.

For a power generation business operator, an estimated value of the coordination potential is important information for adjusting the power generation amount and reducing wasteful power generation. Here, a business model is conceivable that provides the power generation business operator with an estimation result about the extent of the coordination potential in the target region, and receives a consideration. In the business, it is required to improve estimation result accuracy of an estimation model for the estimation of the coordination potential.

The business model that provides an estimation result by an estimation model and obtains a consideration is not specific to a power industry, and is the same in, for example, an industry such as a logistics industry, a retail industry, and a service industry, and the improvement in the estimation result accuracy of the estimation model is a common issue in all industries.

PTL 1 discloses a system that “predicts accuracy of a relearning model in a case where retraining is executed using retraining data including newly collected data”. In the system disclosed in PTL 1, it is disclosed that unnecessary retraining is prevented and the processing cost of retraining of a learning model is reduced by executing determination processing of determining, based on the predicted accuracy of the relearning model, whether to execute retraining.

### CITATION LIST

### Patent Literature

PTL 1: JP2021-184139A

### SUMMARY OF THE INVENTION

It is preferable that an estimation model for estimating a coordination potential in a target region is trained using training data related to the target region. Here, as an example of the training data related to the target region, power smart meter data may be exemplified, and a cost may be required for acquiring the data.

In addition, for training of the estimation model using the data, in general, a calculation cost at the time of training is required. Therefore, the improvement in estimation accuracy of the estimation model by training and the cost required for training are in a trade-off relationship.

In a business model that obtains a consideration by providing an estimated value by an estimation model, when a cost equal to or higher than the consideration is required for training the estimation model, a profit cannot be obtained. It is desirable that training data that maximizes the profit can be selected in consideration of both the cost required for training the model and the consideration obtained from the estimation result of the model.

In the system disclosed in PTL 1, although a reduction in training cost by avoiding unnecessary training is proposed based on prediction of the accuracy improvement of the model by training, a cost required for acquiring training data and a consideration obtained from an estimation result of the model are not mentioned.

The invention has been made in view of the above circumstances, and an object thereof is to provide a training data recommendation system that recommends training data maximizing a profit in consideration of both a cost required for training a model and a consideration obtained from an estimation result of the model.

The above problem is solved by a training data recommendation system including a processor and a memory. The processor performs data collection processing of acquiring training data to be used by an estimation model for training, model accuracy estimation processing of estimating accuracy of an estimation result of the estimation model in a case where the estimation model is trained using the training data, training cost calculation processing of calculating a cost required in the case where the estimation model is trained using the training data, processing of calculating revenue obtained by provision of the estimation result output in the case where the estimation model is trained using the training data, and processing of outputting a training data recommendation result, for which a profit obtained by training of the estimation model is calculated, based on the cost and the revenue.

According to the invention, it is possible to select training data that increases profits.

### BRIEF DESCRIPTION OF THE DRAWINGS

FIG. 1 is a block diagram illustrating a configuration example of a network to which a training data recommendation system according to an embodiment is applied.

FIG. 2 is a diagram illustrating a hardware structure example of the training data recommendation system according to the embodiment.

FIG. 3 is a block diagram illustrating a functional configuration example of a training data recommendation system according to a first embodiment.

FIG. 4 is a diagram illustrating an example of operations of the training data recommendation system according to the first embodiment.

FIG. 5 is a diagram illustrating an example of smart meter data accumulated in a data accumulation unit according to the embodiment.

FIG. 6 is a diagram illustrating an example of estimation model information according to the embodiment.

FIG. 7 is a diagram illustrating an example of training data candidate information according to the embodiment.

FIG. 8 is a flowchart illustrating an example of processing of the training data recommendation system according to the first embodiment.

FIG. 9 is a diagram illustrating a procedure of calculating a change in consideration obtained from a business system according to the first embodiment.

FIG. 10 is a diagram illustrating an example of a procedure of selecting training data for increasing a profit according to the first embodiment.

FIG. 11 illustrates an example of a screen for presenting a training data recommendation result according to the first embodiment.

FIG. 12 is a diagram illustrating an example of a procedure of calculating a consideration obtained when future region information is input according to a second embodiment.

FIG. 13 illustrates an example of a screen for displaying training data recommendation results in units obtained by segmenting a region according to a third embodiment.

FIG. 14 illustrates an example of a screen displaying a training data recommendation result created based on an input of a power demand coordination record of a consumer according to a fourth embodiment.

### DESCRIPTION OF EMBODIMENTS

### First Embodiment

An embodiment will be described with reference to the drawings. The embodiment to be described below do not limit the invention according to the claims, and all of the various elements described in the embodiment and the combinations thereof are not necessarily essential for the solution of the invention.

In the embodiment, a case where a training data recommendation system is applied to an estimation model that estimates a coordination potential of power demand will be described as an example, and the training data recommendation system can also be applied to a system that provides a result estimated by an estimation model of all industries such as a logistics industry, a retail industry, and a service industry.

### Network

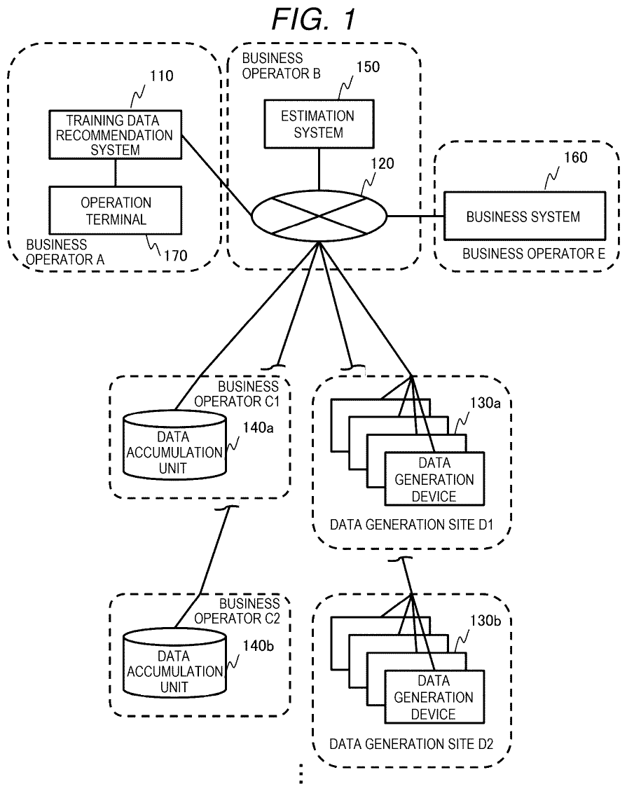

FIG. 1 is a block diagram illustrating a configuration example of a network to which the training data recommendation system according to the embodiment is applied. In FIG. 1, a training data recommendation system 110 is connected to a network 120. One or more data generation devices 130, one or more data accumulation units 140, an estimation system 150, and a business system 160 are connected to the network 120.

An operation terminal 170 for operating the training data recommendation system 110 is connected to the training data recommendation system 110. The operation terminal 170 is not necessarily directly connected to the training data recommendation system 110, and may access the training data recommendation system 110 from a browser via a network.

The data generation device 130 may be, for example, a sensor configured to observe power smart meter data for acquiring a power usage record of a consumer, satellite image data, weather information of a region, or a sensor configured to measure a population flow of a region. Data collected or generated by these data generation devices 130 is transmitted to the data accumulation units 140 via the network 120.

The data accumulation unit 140 is, for example, a storage device such as a server or a memory, and accumulates data collected or generated by the data generation device 130. In addition, metadata such as geographic information on the installation of the data generation device 130 and an operation status of the data generation device 130 may be accumulated.

The metadata may be provided by the data generation device 130, may be provided by a business operator that owns the data generation device 130, or may be provided by a business operator that owns the data accumulation unit 140.

The estimation system 150 includes an estimation model that estimates a coordination potential. The estimation system 150 can estimate the coordination potential, which is output data of the estimation model, based on the data accumulated in the data accumulation unit 140.

The business system 160 runs a business using an estimated value of the coordination potential, which is the output data estimated by the estimation system 150. A business operator that owns the business system 160 may be a power generation business operator, a power distribution business operator, or a renewable energy business operator.

A business operator that owns the training data recommendation system 110 may be the same as a business operator that owns the estimation system 150. The business operator that owns the data accumulation unit 140 may be the same as the business operator that owns the training data recommendation system 110 or the business operator that owns the estimation system 150.

The data accumulation unit 140 may be located in a place where the data generation device 130 exists, or may be located in a place of a business operator that owns the estimation system 150. The business operator that owns the business system 160 may be the same as the business operator that owns the estimation system 150, the business operator that owns the data generation device 130, and the business operator that owns the data accumulation unit 140.

### System Configuration

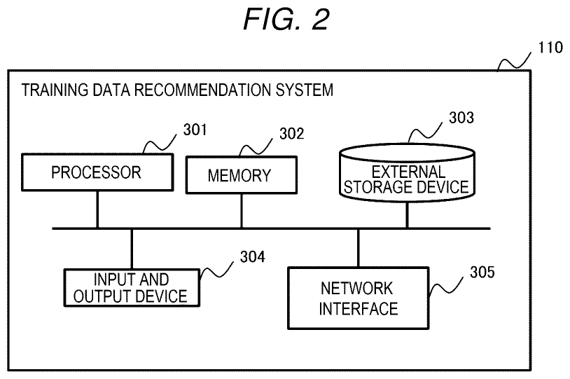

FIG. 2 is a diagram illustrating a hardware structure example of the training data recommendation system according to the embodiment.

The training data recommendation system 110 is implemented on a computer including a processor 301 such as a central processing unit (CPU) or a graphic processing unit (GPU) that performs overall control of the training data recommendation system 110, a memory 302 such as a read only memory (ROM) or a random access memory (RAM) that stores various processing programs for implementing functions of the training data recommendation system 110, an external storage device 303 such as a hard disk drive (HDD) or a solid state drive (SSD), an input and output device 304 such as a keyboard, a mouse, or a touch panel, and a network interface 305 such as a network interface card (NIC).

The functions of the training data recommendation system are implemented by the processor 301 executing various processing programs stored in the memory 302 while referring to data stored in the external storage device 303.

Some or all of these programs may be introduced from another device via a non-transitory storage medium or a communication line, or may be stored in advance. Although an example of implementation using a stand-alone computer will be described in the embodiment, the implementation may be performed by a cloud service that provides computer resources.

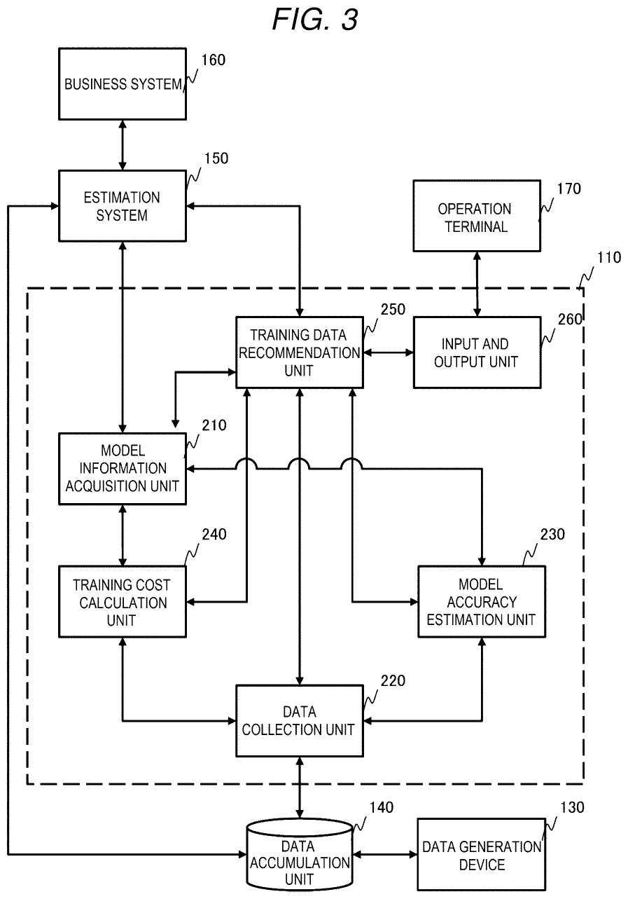

FIG. 3 is a diagram illustrating a hardware structure example of the training data recommendation system according to the first embodiment. As illustrated in FIG. 3, the training data recommendation system 110 includes a model information acquisition unit 210, a data collection unit 220, a model accuracy estimation unit 230, a training cost calculation unit 240, a training data recommendation unit 250, and an input and output unit 260.

The training data recommendation system 110 is connected to the data accumulation unit 140 via the network 120.

The training data recommendation system 110 is connected to the operation terminal 170 via the input and output unit 260. The operation terminal 170 provides a user with an environment for inputting predetermined information to the model information acquisition unit 210, the data collection unit 220, the model accuracy estimation unit 230, the training cost calculation unit 240, and the training data recommendation unit 250.

The training data recommendation system 110 is connected to the estimation system 150 via the network 120. The estimation system 150 is connected to the data accumulation unit 140 via the network 120.

The training data recommendation system 110 estimates, for the estimation model of the estimation system 150, the accuracy of an estimation result of the learned model trained with data acquired from the data accumulation unit 140, and provides the estimation system 150 with a recommendation result of data to be used for training (training data recommendation result) from a cost of training and a consideration obtained by providing the estimation result of the learned model. The estimation system 150 provides an estimation result by the estimation model to the business system 160.

The training data recommendation system 110 receives a training data recommendation system usage fee based on a profit. The profit is obtained from the cost of training and the consideration of the estimation result obtained by the learned model included in the recommendation result of data to be used for training.

### Operation Procedure

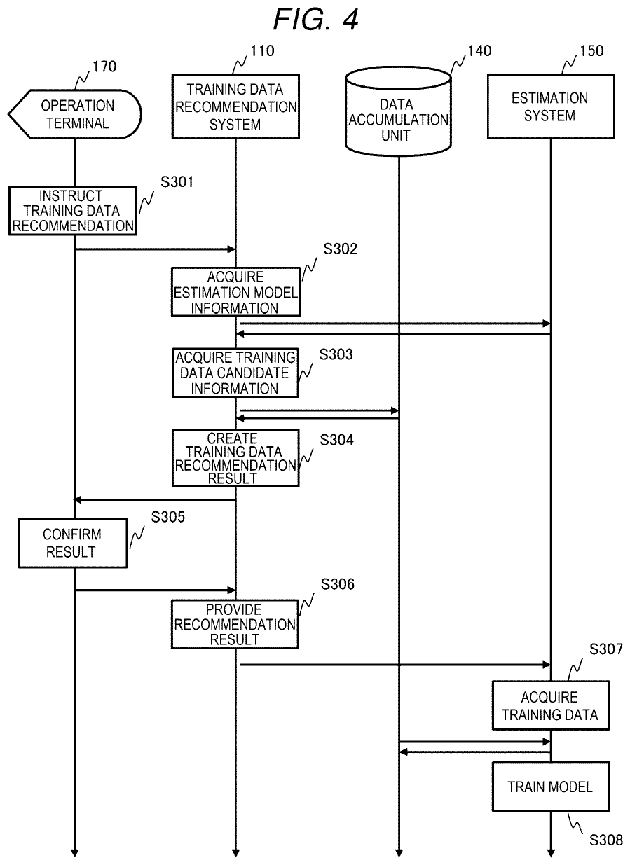

FIG. 4 is a diagram illustrating an example of operations of the training data recommendation system according to the first embodiment.

A user who uses the training data recommendation system 110 uses the operation terminal 170 to issue an instruction for training data recommendation to the training data recommendation system 110 (S301).

Next, the training data recommendation system 110 acquires, from the estimation system 150, estimation model information of an estimation model for recommending training data (S302).

Next, the training data recommendation system 110 acquires, from the data accumulation unit 140, training data candidate information that is information on data serving as a candidate of training data to be used by the estimation system 150 for training (S303).

At this time, a requirement may be imposed on data to be acquired. For example, only data generated in a specific period or region is set as the training data candidate, or the user may designate the requirement on the operation terminal 170.

Next, the training data recommendation system 110 creates, from the training data candidate information, a training data recommendation result as a result of selecting data to be used for training the estimation model in the estimation system 150, and outputs the training data recommendation result to the operation terminal 170 (S304).

The user who uses the training data recommendation system 110 uses the operation terminal 170 to refer to the training data recommendation result presented in S304, and confirms the training data to be used in the estimation system 150 (S305). At this time, the training data recommendation system 110 may output a plurality of training data candidates to the operation terminal 170 and receive training data selection from the user.

The confirmation of the training data recommendation result may be automated by setting a requirement in advance for the training data recommendation result presented by the training data recommendation system 110. If the requirement is not satisfied, the training data recommendation result may be created again.

The user may designate a requirement to be imposed on the training data recommendation result on the operation terminal 170. The training data recommendation result may be created again based on the operation of the user from the operation terminal 170.

Next, the training data recommendation system 110 provides the training data recommendation result to the estimation system 150 (S306).

The estimation system 150 acquires training data from the data accumulation unit 140 based on the training data recommendation result provided by the training data recommendation system 110 (S307).

The estimation system 150 trains the estimation model using the training data acquired from the data accumulation unit 140 (S308).

Here, as long as the training data recommendation system 110 creates the training data recommendation result for the data acquired from the data accumulation unit 140 and the estimation system 150 trains the estimation model based on the training data recommendation result, the sequence of S301 to S308 in FIG. 4 may be changed.

### Data Content

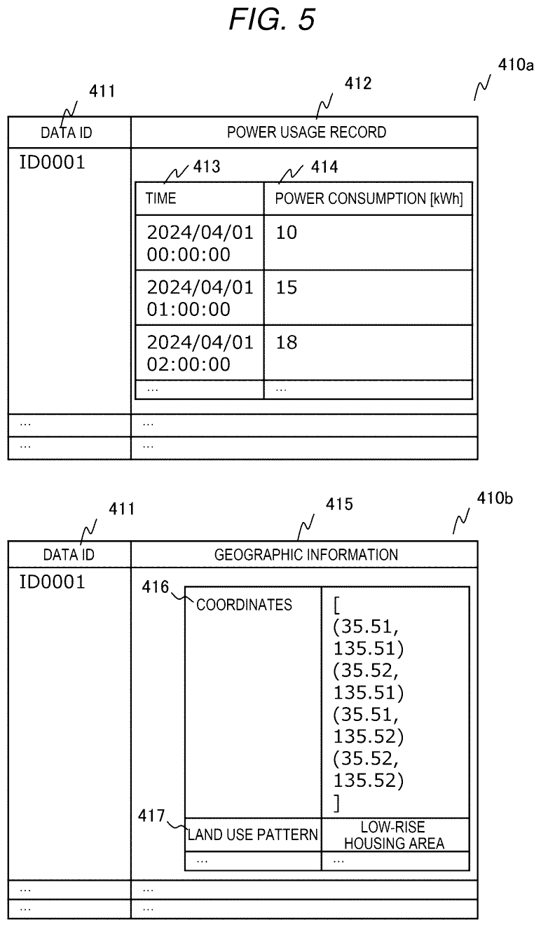

FIG. 5 is a diagram illustrating an example of smart meter data accumulated in the data accumulation unit according to the embodiment. Examples of data registered in the data accumulation unit 140 include smart meter data 410. The smart meter data 410 includes two types of information, that is, power usage record information 410a and geographic information 410b.

410a includes information such as data ID 411 for uniquely identifying a data acquisition source and a power usage record 412 of smart meter data corresponding to the data ID 411. The power usage record 412 is time-series data for recording power consumption 414 at a time 413.

410b includes information such as the data ID 411 for uniquely identifying an acquisition source of smart meter data, and geographic information 415 on a position where the smart meter data corresponding to the data ID 411 occurs.

In addition, the geographic information 415 includes information on coordinates 416 related to a position where the smart meter data occurs and a land use pattern 417 related to the position where the smart meter data occurs. The coordinates 416 include latitude and longitude information. The coordinates 416 may be information representing a polygon shape including position information of a plurality of points.

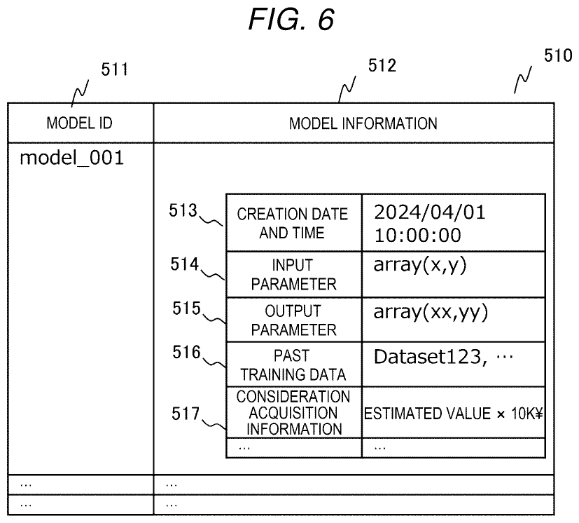

FIG. 6 is a diagram illustrating an example of estimation model information according to the embodiment. Estimation model information 510 includes information such as a model ID 511 for uniquely identifying an estimation model and model information 512 indicating details of the estimation model.

The model information 512 includes information of a creation date and time 513 indicating a date and time when the model is created, an input parameter 514 indicating a format of input data to the model, an output parameter 515 indicating a format of output data from the model, past training data 516 indicating information on training data used in training the model in the past, and consideration acquisition information 517 indicating a relationship between a consideration obtained by the estimation system 150 from the business system 160 and an estimated value of the model.

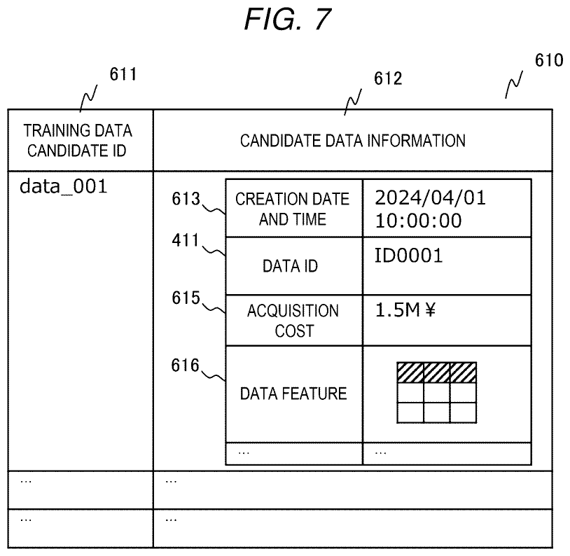

FIG. 7 is a diagram illustrating an example of training data candidate information according to the embodiment. The training data candidate information 610 includes information such as a training data candidate ID 611 for uniquely identifying a training data candidate that is a candidate of training data, and candidate data information 612 indicating information on the training data candidate.

The candidate data information 612 includes information such as a creation date and time 613 indicating a date and time when the training data candidate is created, the data ID 411 for uniquely identifying a data acquisition source, an acquisition cost 615 indicating information on a cost required to acquire the data, and a data feature 616 indicating a feature of the training data candidate. In this example, information indicating a region in which the candidate data is acquired is stored.

### Training Data Recommendation Result Creation Processing

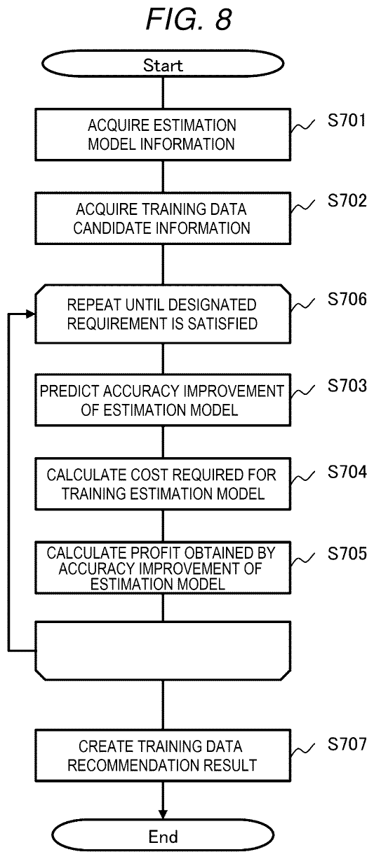

FIG. 8 is a flowchart illustrating an example of processing of the training data recommendation system according to the first embodiment. The procedure illustrated in FIG. 8 corresponds to S302 to S304 in the operation procedure illustrated in FIG. 4.

In S302, the model information acquisition unit 210 acquires, from the estimation system 150, estimation model information that is information on an estimation model in the estimation system 150 (S701).

In S303, the data collection unit 220 acquires, from the data accumulation unit 140, training data candidate information as information on data serving as a candidate of training data to be used by the estimation system 150 for training (S702).

In S304, the model accuracy estimation unit 230 uses the information on the estimation model of the estimation system 150 acquired in S701 and the training data candidate information acquired in S702 to predict accuracy improvement of an estimation result of the estimation model in a case where training is performed using a specific training data candidate in the training data candidate information (S703).

In S304, the training cost calculation unit 240 uses the training data candidate information acquired in S702 to calculate, for the estimation model of the estimation system 150, a cost required when training is performed with the specific training data candidate in the training data candidate information (S704).

In S304, the training data recommendation unit 250 calculates a change in consideration obtained from the business system 160, which is caused by accuracy improvement of the estimation result of the estimation model predicted in S703 (S705).

At this time, regarding the consideration obtained by providing output data of the estimation model of the estimation system 150 to the business system 160, information indicating a relationship between the estimation result output by the model and the accuracy thereof and the obtained consideration may be provided from the estimation system 150 or may be provided from the business system 160 as the consideration acquisition information 517 included in the estimation model information 510, for example.

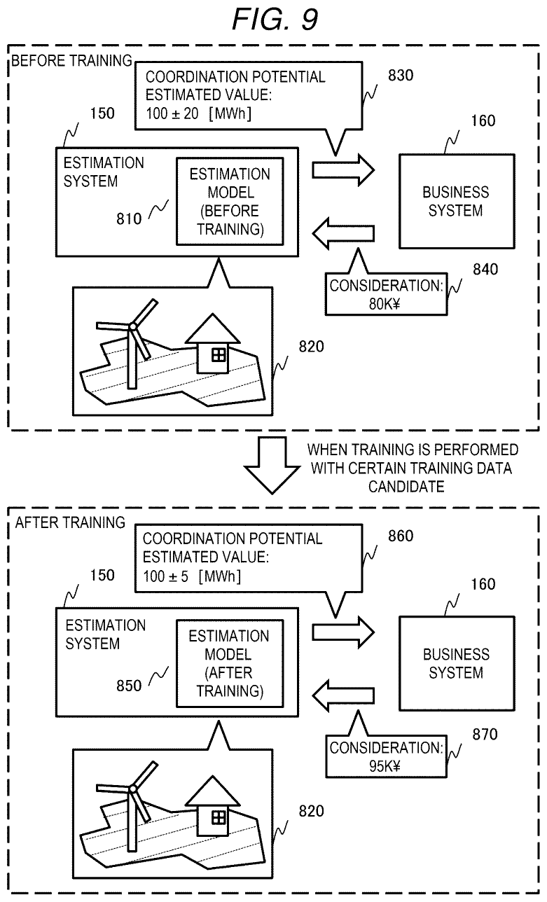

A procedure in which the training data recommendation unit 250 calculates a change in the consideration generated by accuracy improvement of the output data of the estimation model will be described later with reference to FIG. 9.

The processing from S703 to S705 for the specific training data candidate of the training data candidate information may be repeatedly performed until a preset requirement is satisfied. All the training data candidates in the training data candidate information may be searched for, or the search for the training data candidates may be repeated until the number of training data candidates, by which the accuracy of the output data of the trained estimation model exceeds preset accuracy, reaches a preset threshold.

In addition, the user may designate, on the operation terminal 170, an end requirement of the search processing for the training data candidate in the training data candidate information (S706). In S706, when all the training data candidates in the training data candidate information are searched, the training data recommendation unit 250 can select the training data candidate having the lowest training cost by which the accuracy of the estimation result of the trained estimation model reaches the preset accuracy.

In S304, the training data recommendation unit 250 sets the training data candidate having the maximum profit as the training data recommendation result based on the cost calculated in S704 and the consideration calculated in S705 (S707).

### Calculation of Consideration Obtained by Accuracy Improvement

FIG. 9 is a diagram illustrating a procedure of calculating a change in consideration obtained from the business system according to the first embodiment. Smart meter data of a target region and land use pattern information that is feature information of the region are provided to an estimation model 810 before training of the estimation system 150 as input information (820), and a coordination potential of the target region is estimated (830).

The business system 160 pays a consideration to the estimation system 150 for the provision of an estimated value of the coordination potential from the estimation system 150 (840). The consideration to be paid from the business system 160 to the estimation system 150 is calculated based on the estimated value of the coordination potential and the accuracy thereof.

For example, as an estimation result in the estimation model 810 before training, when the coordination potential falls within a range of 100±20 MWh with an accuracy of 90%, a rule may be set in which a consideration to be paid is calculated based on 80 MWh serving as the minimum value of the range and 80 k¥ is paid. Hereinafter, a description will be made based on the rule.

Here, a case where the estimation model 810 is trained using a certain training data candidate will be described as an example. An estimation model 850 after training of the estimation system 150 uses the smart meter data and the land use pattern information of the target region as input information (820), and estimates the coordination potential in the target region (860). The business system 160 pays a consideration to the estimation system 150 for the provision of the estimated value of the coordination potential from the estimation system 150 (870).

As the estimation result in the estimation model 850 after training, when the coordination potential falls within a range of 100±5 MWh with the accuracy of 90%, the consideration to be paid from the business system 160 to the estimation system 150 is 95 k¥.

Therefore, with the accuracy improvement of the estimation model of the estimation system 150, the consideration paid from the business system 160 to the estimation system 150 is changed from 80 k¥ to 95 k¥.

### Creation of Training Data Recommendation Result

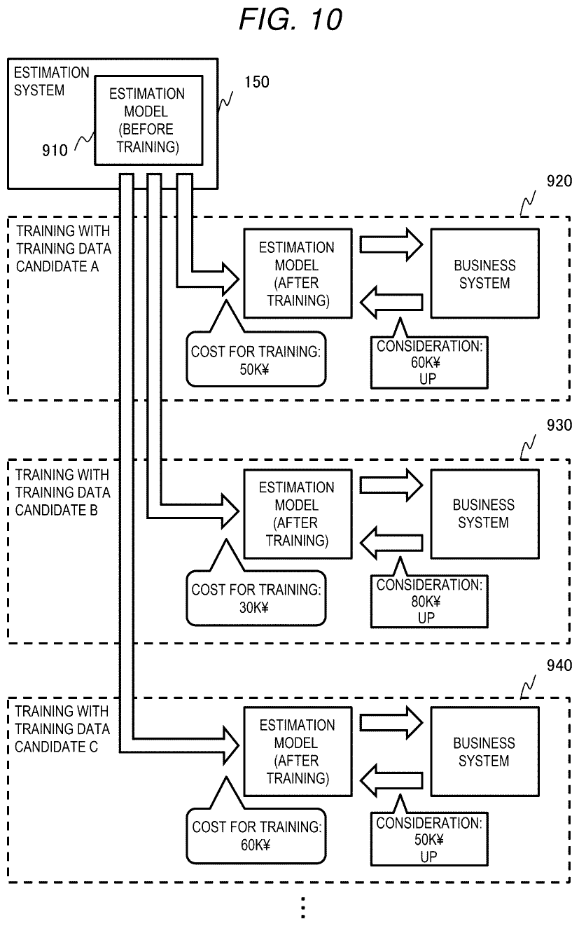

FIG. 10 is a diagram illustrating an example of a procedure of selecting training data for increasing a profit according to the first embodiment. A case where an estimation model 910 of the estimation system 150 is trained with a training data candidate A (920), a case where the estimation model 910 is trained with a training data candidate B (930), and a case where the estimation model 910 is trained with a training data candidate C (940) are compared.

In the case where training is performed with the training data candidate A, it is assumed that the cost required for training is 50 k¥ and the consideration received by the estimation system 150 increases by 60 k¥.

In the case where training is performed with the training data candidate B, it is assumed that the cost required for training is 30 k¥ and the consideration received by the estimation system 150 increases by 80 k¥.

In the case where training is performed with the training data candidate C, it is assumed that the cost required for training is 60 k¥ and the consideration received by the estimation system 150 increases by 50 k¥. At this time, since the case of training with the training data candidate B has the largest profit, the training data candidate B is set as the training data candidate recommendation result.

As described above, in a case where the estimation model 910 is trained with one or more training data candidates, a training data candidate, by which a profit calculated using a cost required for training and a consideration received by the estimation system 150 is maximized, is set as the training data recommendation result.

Here, a priority of training may be given in descending order of profit, and a plurality of training data candidates may be presented to the user together with the priority.

In addition, the training may be performed with a plurality of training data candidates, and a combination of training data candidates by which the profit is maximized may be presented to the user as the training data recommendation result.

### Screen Display

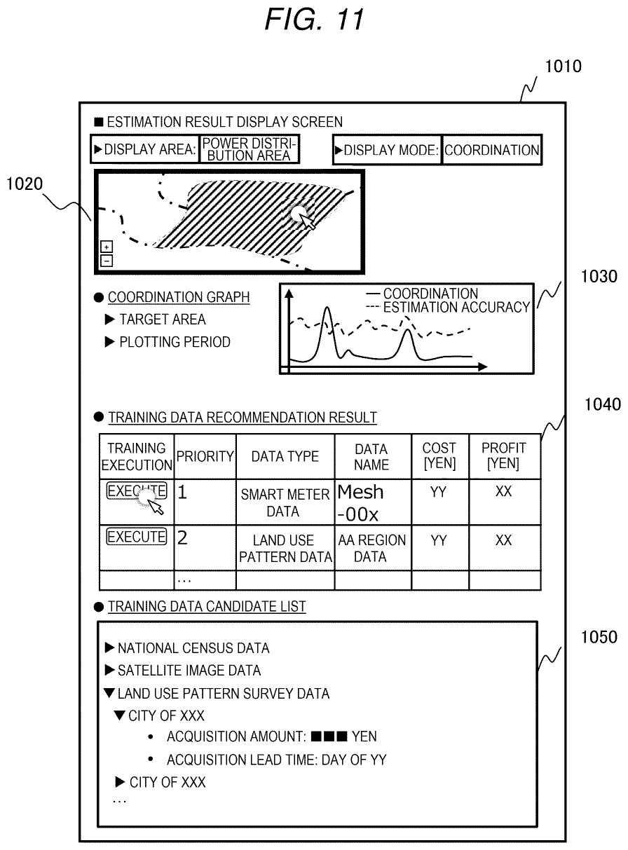

FIG. 11 is a diagram illustrating an example of a screen for presenting a training data recommendation result according to the first embodiment. In FIG. 11, a screen 1010 includes an area 1020 for setting a region to be estimated for the coordination potential that is shown in diagonal lines, an area 1030 for displaying an estimated coordination potential and accuracy thereof, an area 1040 for displaying a training data recommendation result, and an area 1050 for displaying a list of training data candidates.

The area 1020 displays map information obtained by superimposing power distribution areas. Any one or more power distribution areas may be selectable by a user operation. Information on the coordination potential in the power distribution area selected in the area 1020, which is estimated by the estimation model of the estimation system 150, is displayed. As the information on the coordination potential, a numerical value of the coordination potential may be displayed, or the value of the coordination potential may be expressed by a color.

The area 1020 may display the estimation accuracy of the coordination potential as the information on the coordination potential. In addition, an estimation result of accuracy improvement by performing training may be displayed.

The area 1030 has a function of displaying time-series information on the coordination potential estimated by the estimation model of the estimation system 150. In the area 1030, the user can set a period for displaying the time-series information.

The area 1030 may display both the numerical value of the coordination potential and the estimation accuracy of the coordination potential, or may display other types of information.

The area 1040 has a function of displaying the training data recommendation result created by the training data recommendation unit 250. The training data recommendation result shows a type of the data, a profit obtained by subtracting a cost from a consideration obtained by training using the data, and the like.

A plurality of training data candidates may be included in the training data recommendation result, and may be displayed together with the priority of training. In addition, a function of instructing training based on a user operation by using the displayed training data recommendation result may be provided.

In the area 1040, only training data candidates, by which the estimation accuracy of the coordination potential output by the trained estimation model of the estimation system 150 satisfies preset accuracy, may be output as the training data recommendation result.

In the area 1040, the training data candidates may be sorted and rearranged by the cost related to training based on the order of presentation to the user.

The area 1050 has a function of displaying a list of training data candidates acquired by the data collection unit 220 from the data accumulation unit 140. For the display of the list of training data candidates, the type of the data, a cost required for acquiring the data, a profit, a lead time required for acquiring the data, and the like may be displayed.

The screen 1010 may interactively provide information to the user by using artificial intelligence represented by generative AI.

### Second Embodiment

An example of a procedure in which the training data recommendation system 110 according to a second embodiment presents a training data recommendation result to a user will be described.

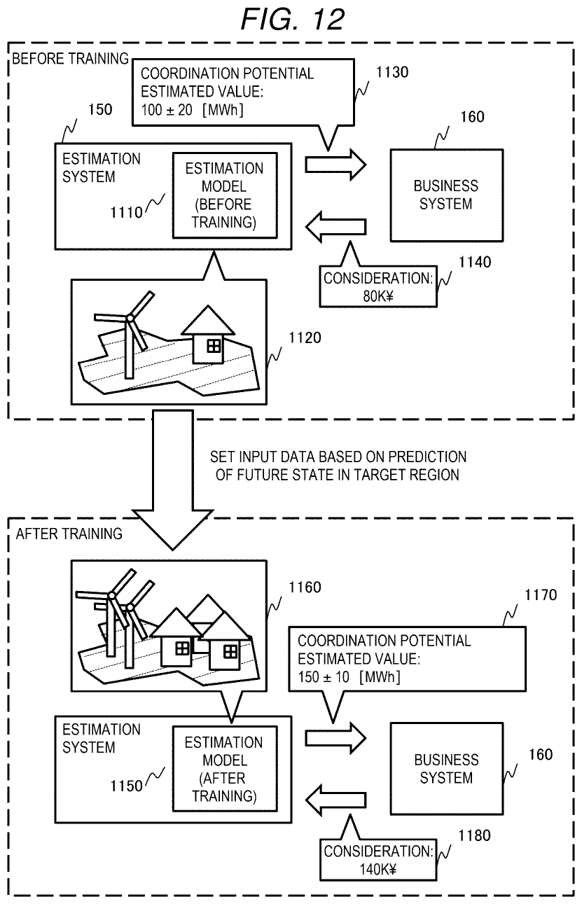

FIG. 12 is a diagram illustrating an example of a procedure of calculating a consideration obtained when future region information is input according to the second embodiment. An estimation model 1110 before training of the estimation system 150 uses, as input information (1120), smart meter data of a target region and land use pattern information that is feature information of the region, and estimates a coordination potential of the target region (1130).

The business system 160 pays a consideration to the estimation system 150 for the provision of an estimated value of the coordination potential from the estimation system 150 (1140). The consideration to be paid from the business system 160 to the estimation system 150 is calculated based on the estimated value of the coordination potential and the accuracy thereof.

For example, as an estimation result in the estimation model 1110 before training, when the coordination potential falls within a range of 100±20 MWh with an accuracy of 90%, a rule may be set in which a consideration to be paid is calculated based on 80 MWh serving as the minimum value of the range and 80 k¥ is paid. Hereinafter, a description will be made based on the rule.

A case where the estimation model 1110 is trained using a certain training data candidate will be described as an example. The estimation model 1150 after training of the estimation system 150 may predict a future state based on the smart meter data of the target region and the land use pattern information, use a prediction result as the input information (1160), and estimate the coordination potential of the target region (1170).

Information predicted by the training data recommendation system 110 may be used as information on the future state of the target region that is used as the input information by the estimation model 1150. The future state may be predicted based on information such as a land development plan of the target region, a change in weather conditions, and a line of policy.

The business system 160 pays a consideration to the estimation system 150 for the provision of the estimated value of the coordination potential from the estimation system 150 (1180). For example, as the estimation result in the estimation model 1150 after training, when the coordination potential falls within a range of 150±10 MWh with an accuracy of 90%, the consideration to be paid from the business system 160 to the estimation system 150 is 140 k¥.

The training data recommendation system 110 may calculate a profit based on a consideration obtained in the future from the business system 160 by the estimation system 150 and create a training data recommendation result.

### Third Embodiment

An example of a procedure in which the training data recommendation system 110 according to a third embodiment presents a training data recommendation result to a user will be described.

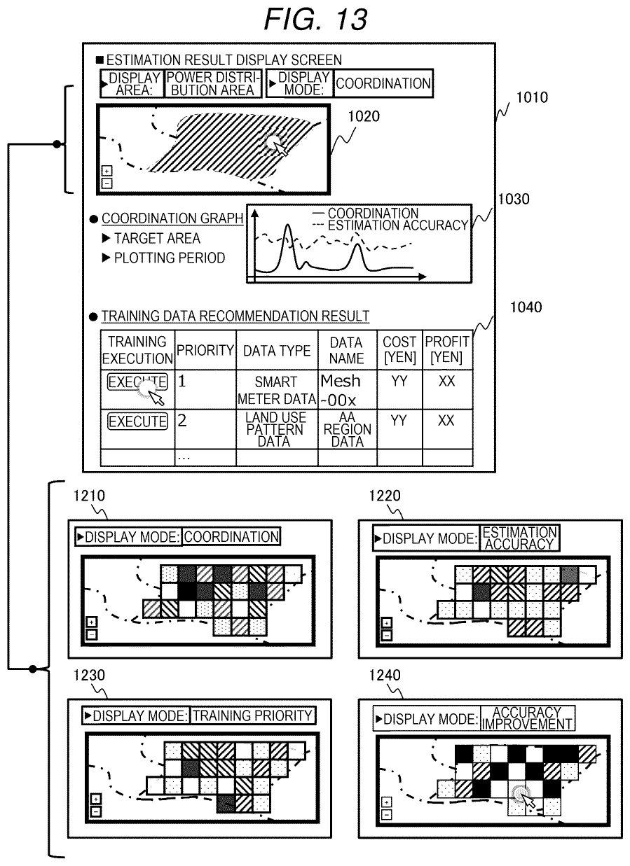

FIG. 13 illustrates an example of a screen for displaying a training data recommendation result in units obtained by segmenting a region according to the third embodiment. For data such as smart meter data and land use pattern information, an acquirable region unit may be designated. For example, the smart meter data may be acquired from units of several kilometers square.

Since a power distribution area is generally a region extending over one or more municipalities, there may be a plurality of pieces of data such as smart meter data and land use pattern information of the power distribution area for which a coordination potential is to be estimated. The estimation system 150 may segment the power distribution area into units from which the smart meter data can be acquired, and estimate the coordination potential in the segmented units.

A value of estimated coordination varies depending on the land use pattern, weather conditions, and the like for each segment obtained by segmenting the power distribution area. In a mountainous region where no building exists, the coordination is small and is estimated with high accuracy.

In a region where there is a commercial facility in which many cold and heat storage devices are introduced, the coordination is high and is estimated with low accuracy. The training data recommendation system 110 may display a numerical value of the coordination potential for each segment (1210), or may display estimation accuracy of the coordination potential (1220).

For each segment, the training data recommendation system 110 may estimate a profit obtained by training, based on a numerical value of estimated coordination, accuracy of the estimated coordination, accuracy improvement of an estimation model in a case where training is performed using data acquirable in the segment, and a training cost in a case where training is performed using data acquirable in the segment. In addition, a training priority according to the profit obtained by training may be displayed (1230).

Here, for each region of the power distribution area, some segments thereof may share similar information such as the land use pattern and the weather condition. When training is performed using data acquirable in a certain segment of the region, improvement in estimation accuracy is also expected in a segment of the region that is similar to the segment of the region.

When training is performed using data acquirable in a certain segment of a region, the training data recommendation system 110 estimates improvement in estimation accuracy with respect to the entire target region for which the coordination potential is to be estimated, and presents a profit obtained by training to a user.

When the user selects a training data candidate, the training data recommendation system 110 may display, to the user, an improvement degree of estimation accuracy or an improvement degree of the profit obtained by training for each segment in a case where training is performed with the training data candidate (1240).

At this time, for segments having a similar improvement degree of the estimation accuracy, information on the land use pattern or the like in regions to which the segments belong may be presented to the user, the information being the reason for being considered to be similar.

### Fourth Embodiment

An example of a procedure in which the training data recommendation system 110 according to a fourth embodiment presents a training data recommendation result to a user will be described.

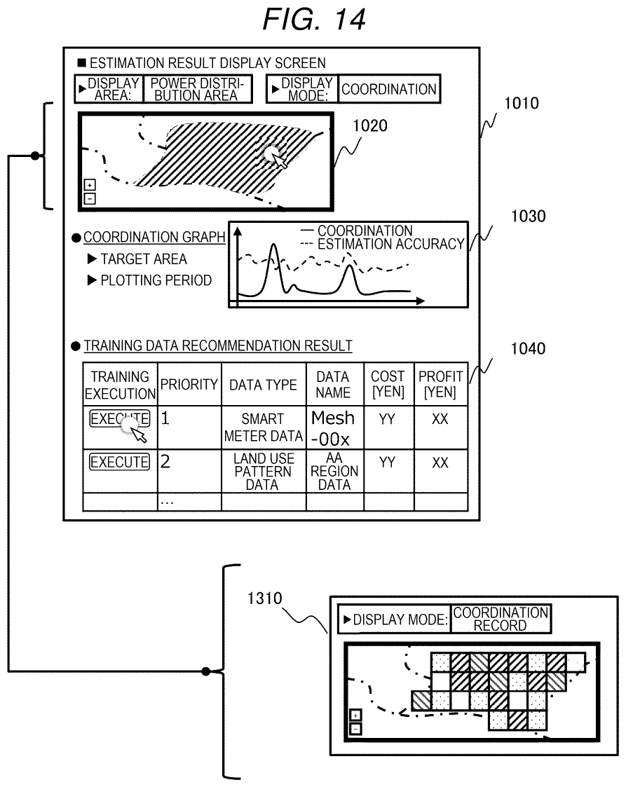

FIG. 14 illustrates an example of a screen displaying a training data recommendation result created based on an input of a power demand coordination record of a consumer according to the fourth embodiment.

For example, the estimation system 150 segments the power distribution area into units from which the smart meter data can be acquired, and estimates the coordination potential in the segmented units.

For a unit obtained by segmenting the power distribution area, segment training data having a significant coordination record of the power demand coordination by a consumer belonging to the segment is acquired as a candidate. The coordination record data is acquired and accumulated by a business operator owning the business system 160.

The training data recommendation system 110 displays a numerical value of the coordination record of the power demand coordination for each segment (1310), and displays a segment having a large record value of the power demand coordination. The training data recommendation system 110 is trained with training data of a segment designated by the user. By receiving such designation of the user, it is possible to estimate the coordination potential from the training data of the segment having a significant coordination record.

In addition, the training data of a segment having a significant record value may be selected without receiving designation of the user.

In a segment A and a segment B that are considered to have the same coordination, adjustment of an operation time of cold and heat storage devices operating in a large supermarket in the segment A cannot be changed due to restriction of hardware, and when coordination record data is acquired, the segment A has almost no coordination record. In such a case, with the above function, it is possible to give an instruction to preferentially train with data of the segment B.

As described above, according to the above-described embodiments, the training data recommendation system 110 can provide a user with training data that maximizes a profit, the profit being calculated from a cost for training an estimation model of the estimation system 150 and a consideration received by the estimation system 150 from the business system 160.

In the above-described embodiments, an example in which training data is recommended using an estimation model that estimates a coordination potential in a power industry has been described, and the training data recommendation system 110 is not limited to the power industry and can be applied to any industry.

The invention is not limited to the above-described embodiments and includes various modifications. For example, the above-described embodiments have been described in detail to facilitate understanding of the invention, and the invention is not necessarily limited to those including all the configurations described above.

A part of a configuration of a certain embodiment can be replaced with a configuration of another embodiment, and a configuration of another embodiment can also be added to a configuration of a certain embodiment.

In addition, another configuration can be added to a part of a configuration of each embodiment, and the part of the configuration of each embodiment can be deleted or replaced with another configuration. A part or all of configurations, functions, processing units, processing methods, and the like described above may be implemented by hardware by, for example, designing with an integrated circuit.

What is claimed is:

1. A training data recommendation system comprising:
a processor; and
a memory, wherein
the processor performs
data collection processing of acquiring training data to be used by an estimation model for training,
model accuracy estimation processing of estimating accuracy of an estimation result of the estimation model in a case where the estimation model is trained using the training data,
training cost calculation processing of calculating a cost required in the case where the estimation model is trained using the training data,
processing of calculating a consideration obtained by provision of the estimation result output in the case where the estimation model is trained using the training data, and
processing of outputting a training data recommendation result, for which a profit obtained by training of the estimation model is calculated, based on the cost and the consideration.

2. The training data recommendation system according to claim 1, wherein
the training data recommendation system outputs, based on the cost and the consideration, training data that has a lower cost for the estimation model to achieve predetermined estimation accuracy of the estimation result.

3. The training data recommendation system according to claim 1, wherein
the training data recommendation system outputs, based on the cost and the consideration, training data for maximizing the profit obtained by the training of the estimation model.

4. The training data recommendation system according to claim 3, wherein
the estimation result is a coordination potential for power demand.

5. The training data recommendation system according to claim 4, wherein
the estimation model estimates the coordination potential of a region by using feature information of the region as an input.

6. The training data recommendation system according to claim 5, wherein
an estimated value, which is estimated by the estimation model and based on the coordination potential and the estimation accuracy, is provided, and a profit is calculated.

7. The training data recommendation system according to claim 5, wherein
the estimation model receives prediction of future feature information of the region, and estimates and outputs a future coordination potential of the region.

8. The training data recommendation system according to claim 5, wherein
the estimation model estimates the coordination potential in units obtained by segmenting the region, and outputs an estimation value of the coordination potential in the segmented units and estimation accuracy.

9. The training data recommendation system according to claim 8, wherein
the training data recommendation system outputs an improvement degree of the estimation accuracy of the coordination potential and an improvement degree of the obtained profit in a case where the estimation model is trained with training data of segments having similar region information, the segments being obtained by segmenting the region.

10. The training data recommendation system according to claim 5, wherein
based on a power demand coordination record in segments belonging to the region for which the coordination potential is to be estimated, the training data recommendation system estimates the coordination potential of the region by using training data of a segment having a significant coordination record among the segments.

11. A training data recommendation method comprising a processor:
acquiring training data to be used by an estimation model for training;
predicting accuracy of an estimation result of the estimation model in a case where the estimation model is trained using the training data;
calculating a cost required in the case where the estimation model is trained using the training data;
calculating a consideration obtained by provision of the estimation result output in the case where the estimation model is trained using the training data; and
outputting a training data recommendation result, for which a profit obtained by training of the estimation model is calculated, based on the cost and the consideration.
